(19) United States
(12) Patent Application Publication
(10) Pub. No.: US 2026/0130817 A1
(43) Pub. Date: May 14, 2026

(54) DOUBLE-HEAD ROTARY TELESCOPIC MASTURBATION CUP

(71) Applicant: Liang CHEN, Shenzhen (CN)

(72) Inventor: Liang CHEN, Shenzhen (CN)

(21) Appl. No.: 18/948,224

(22) Filed: Nov. 14, 2024

(51) Int. Cl. A61H 19/00

(52) U.S. Cl. CPC A61H 19/32; A61H 2201/0192; A61H 2201/1215; A61H 2201/1454; A61H 2201/1673

(57) ABSTRACT

The present invention discloses a double-head rotary telescopic masturbation cup, including: a housing assembly; a rotary telescopic mechanism movably disposed in the housing assembly; and a double-head massage body detachably disposed in the rotary telescopic mechanism in a penetrating manner. The rotary telescopic mechanism includes: a support housing; two rotary bearings respectively arranged on the support housing; a rotating cylinder with two ends movably disposed on the two rotary bearings respectively, and a telescopic guide sliding rail and a transmission rack fixedly disposed on the rotating cylinder in a surrounding manner respectively, where the double-head massage body is detachably disposed in the rotating cylinder; a driving structure disposed on the support housing and in transmission connection with the transmission rack, which can rotate forwards and backwards.

### TECHNICAL FIELD

The present invention relates to the technical field of adult products, and in particular, to a double-head rotary telescopic masturbation cup.

### BACKGROUND

With the development of economy and progress of the society, the heavy and busy fast pace makes men's working pressure greater, and therefore, alleviating daily working pressure has become a necessity and a social consensus. Various electric appliances are increasingly developing in the direction of alleviating working pressure, being convenient to use, being safe and efficient, etc., and a masturbation cup, as an important member among the electric appliances of people's live, is no exception. Currently, an existing masturbation cup is generally configured to a single head, a user can only carry out massage operation from one direction, and the appearance and the playing method of the existing masturbation cup are relatively simple, which cannot meet increasing requirements of the user. Therefore, the present invention provides a double-head rotary telescopic masturbation cup for solving the described problem.

### SUMMARY

An objective of the present invention is to provide a double-head rotary telescopic masturbation cup, so as to solve problems that an existing masturbation cup is relatively simple in appearance and playing method.

A double-head rotary telescopic masturbation cup provided by the present invention can be implemented through the following technical solution:
a double-head rotary telescopic masturbation cup provided by the present invention includes: a housing assembly; a rotary telescopic mechanism movably disposed in the housing assembly, where the rotary telescopic mechanism can synchronously perform rotation operation and telescopic operation relative to the housing assembly; and a double-head massage body detachably disposed in the rotary telescopic mechanism in a penetrating manner, where
the rotary telescopic mechanism includes: a support housing slidably disposed in the housing assembly in a penetrating manner; two rotary bearings respectively arranged on the support housing; a rotating cylinder with two ends movably disposed on the two rotary bearings respectively, and a telescopic guide sliding rail and a transmission rack fixedly disposed on the rotating cylinder in a surrounding manner respectively, where the double-head massage body is detachably disposed in the rotating cylinder, and the telescopic guide sliding rail is obliquely disposed; a driving structure disposed on the support housing and in transmission connection with the transmission rack, which can rotate forwards and backwards, where the driving structure drives the rotating cylinder to rotate through the transmission rack; and a guide structure fixedly disposed on the housing assembly and penetrating through the support housing to be in contact connection with the telescopic guide sliding rail, which performs limiting and guiding operation on the telescopic guide sliding rail.

In an embodiment, the housing assembly includes: a main housing, which is a hollow cavity with openings at two ends, where the rotary telescopic mechanism movably penetrates through the main housing; and a first cover body and a second cover body detachably disposed at the two ends of the main housing respectively.

In an embodiment, two handles are fixedly disposed on the main housing.

In an embodiment, a plurality of mounting columns are fixedly disposed on an inner wall of the main housing respectively; and a plurality of guide shafts are fixedly disposed on the support housing, a linear bearing is movably disposed on each guide shaft in a penetrating manner, the linear bearing is fixedly disposed in the corresponding mounting column, and the guide shaft can move relative to the corresponding linear bearing.

In an embodiment, a plurality of clamping grooves are disposed at the two ends of the main housing respectively; and a plurality of buckles are fixedly disposed on inner walls of the first cover body and the second cover body respectively, and positions of the plurality of buckles are matched with positions of the corresponding clamping grooves.

In an embodiment, a motor housing is detachably and fixedly disposed on the support housing, and the driving structure is disposed in the motor housing.

In an embodiment, the driving structure includes: a gear motor, which can rotate forwards and backwards, where the gear motor fixedly disposed in the motor housing; and a driving gear fixedly disposed on a rotating shaft of the gear motor, which is in transmission connection with the transmission rack in a meshing manner.

In an embodiment, the guide structure includes: a mounting base detachably and fixedly disposed in the main housing in a penetrating manner; two mounting shafts fixedly disposed on the mounting base respectively and penetrating through the support housing respectively; and two bearings rotatably disposed on the corresponding mounting shafts respectively.

In an embodiment, the double-head massage body is made of a soft silica gel material.

In an embodiment, the double-head massage body includes: a massage main body, which is a hollow cavity with openings at two ends; and a massage cover body detachably disposed on the massage main body in a clamping manner.

In an embodiment, the two ends of the massage main body are disposed in a communicating manner.

In an embodiment, the two ends of the massage main body are not in communication with each other.

In an embodiment, a plurality of convex points and a plurality of spiral strips are respectively disposed on an inner wall of the massage main body.

In an embodiment, the plurality of convex points and the plurality of spiral strips are integrally formed with the massage main body.

In an embodiment, a plurality of convex points are disposed on an inner wall of the massage main body, and the plurality of convex points are integrally formed with the massage main body.

In an embodiment, a plurality of spiral strips are disposed on an inner wall of the massage main body, and the plurality of spiral strips are integrally formed with the massage main body.

In an embodiment, the battery assembly adopts a polymer lithium ion battery.

In an embodiment, the double-head rotary telescopic masturbation cup provided by the present invention further includes a circuit board, a battery assembly, a key assembly, and a charging interface, where the circuit board and the battery assembly are fixedly disposed in the housing assembly respectively; the key assembly is disposed on the circuit board and penetrates through the housing assembly; the charging interface is fixedly disposed on the housing assembly in a penetrating manner; and the circuit board is electrically connected to the rotary telescopic mechanism, the battery assembly, the key assembly, and the charging interface, respectively.

In an embodiment, the electrical interface adopts one or more of a DC charging interface, a Type C charging interface, a Micro USB charging interface, and a Lightning charging interface.

Compared with the prior art, beneficial effects of the double-head rotary telescopic masturbation cup provided by the present invention are as follows:

According to the double-head rotary telescopic masturbation cup provided by the present invention, through the double-head arrangement, the shape of the masturbation cup is changed to a large extent compared with an existing masturbation cup, a user can randomly select one end for massage operation, so that a better playing method can be unlocked, and the interestingness and playability of the masturbation cup are improved. In addition, the gear motor sequentially passes through the driving gear and the transmission rack to drive the rotating cylinder to rotate, so that a rotating function of the double-head massage body disposed on the rotating cylinder is realized, meanwhile, the support housing is driven to move relative to the main housing through cooperation of the telescopic guide sliding rail disposed on the rotating cylinder and the guide structure, so that the double-head massage body disposed on the rotating cylinder also moves along with the support housing, and then the telescopic operation of the double-head massage body is synchronously realized through forward and reverse rotation of the driving structure. This effectively solves problems that the existing masturbation cup is relatively simple in appearance and playing method.

### BRIEF DESCRIPTION OF THE DRAWINGS

To describe the technical solutions in the embodiments of the present invention more clearly, the following briefly describes the accompanying drawings required for describing the embodiments. It should be understood that, the following accompanying drawings show merely some embodiments of the present invention, and therefore should not be regarded as a limitation on the scope. A person of ordinary skill in the art may still derive other related drawings from these accompanying drawings without creative efforts.

FIG. 1 is a schematic structural diagram of a double-head rotary telescopic masturbation cup according to the present invention;

FIG. 2 is a schematic diagram of a separation structure of a double-head rotary telescopic masturbation cup according to the present invention shown in FIG. 1;

FIG. 3 is a schematic diagram of a cross-sectional structure of a double-head rotary telescopic masturbation cup according to the present invention shown in FIG. 1;

FIG. 4 is a schematic diagram of an explosion structure of a double-head rotary telescopic masturbation cup according to the present invention shown in FIG. 1, including a rotary telescopic mechanism and a double-head massage body;

FIG. 5 is a schematic diagram of a cross-sectional structure of a rotary telescopic mechanism shown in FIG. 4;

FIG. 6 is a schematic diagram of an explosion structure of a rotary telescopic mechanism shown in FIG. 4, including a guide structure;

FIG. 7 is a schematic diagram of an explosion structure of a guide structure shown in FIG. 6; and

FIG. 8 is a schematic diagram of a cross-sectional structure of a double-head massage body shown in FIG. 4.

### IN THE FIGURES

10. double-head rotary telescopic masturbation cup; 11. housing assembly; 111. main housing; 1111. handle; 1112. mounting column; 1113. through hole; 1114. clamping groove; 112. first cover body; 1121. buckle; 113. second cover body; 12. circuit board; 13. rotary telescopic mechanism; 131. support housing; 1311. motor housing; 1312. guide shaft; 1313. linear bearing; 132. rotary bearing; 133. rotating cylinder; 1331. telescopic guide sliding rail; 134. driving structure; 1341. gear motor; 1342. driving gear; 135. transmission rack; 136. guide structure; 1361. mounting base; 1362. mounting shaft; 1363. bearing; 14. double-head massage body; 141. massage main body; 1411. convex point; 1412. spiral strip; 142. massage cover body; 15. battery assembly; 16. key assembly; 17. charging interface.

### DETAILED DESCRIPTION OF THE EMBODIMENTS

To make the objectives, technical solutions, and advantages of the embodiments of the present invention clearer, the following clearly and completely the technical solutions in the embodiments of the present invention with reference to the accompanying drawings in the embodiments of the present invention. Apparently, the described embodiments are some but not all of the embodiments of the present invention. Components of the embodiments of the present invention described and illustrated in the accompanying drawings can be arranged and designed in various different configurations.

Therefore, the detailed description of the embodiments of the present invention provided in the accompanying drawings is not intended to limit the scope of the claimed invention, but only to represent selected embodiments of the present invention. Based on the embodiments in the present invention, all other embodiments obtained by those of ordinary skill in the art without making creative labor fall within the scope of protection of the present invention.

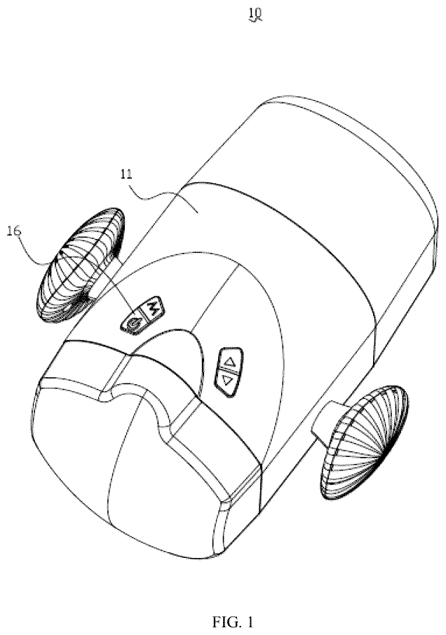

As shown in FIG. 1 to FIG. 4, a double-head rotary telescopic masturbation cup 10 provided by the present invention mainly includes a housing assembly 11, a circuit board 12, a rotary telescopic mechanism 13, a double-head massage body 14, a battery assembly 15, a key assembly 16 and a charging interface 17. The housing assembly 11 is a hollow cavity; the circuit board 12 and the battery assembly 15 are fixedly disposed in the housing assembly 11 respectively, the circuit board 12 is electrically connected to the rotary telescopic mechanism 13, the double-head massage body 14, the battery assembly 15, the key assembly 16, respectively, and the battery assembly 15 provides electric energy for the circuit board 12 and the rotary telescopic mechanism 13, respectively; the rotary telescopic mechanism 13 is movably disposed in the housing assembly 11 and can synchronously perform rotation operation and telescopic operation relative to the housing assembly 11; the double-head massage body 14 is detachably disposed in the rotary telescopic mechanism 13 in a penetrating manner and moves along with the movement of the rotary telescopic mechanism 13; the key assembly 16 is disposed on the circuit board 12 and penetrates through the housing assembly 11, and on-off operation and function setting can be performed through the key assembly 16; and the charging interface 17 is fixedly disposed on the housing assembly 11 in a penetrating manner and is electrically connected to the circuit board 12, and performs charging operation on the battery assembly 15.

As shown in FIG. 1 to FIG. 4, in this embodiment, the housing assembly 11 includes a main housing 111, a first cover body 112, and a second cover body 113. The main housing 111 is a hollow cavity with openings at two ends, and the rotary telescopic mechanism 13 movably penetrates through the main housing 111; and the first cover body 112 and the second cover body 113 are detachably disposed at two ends of the main housing 111 respectively and form a hollow closed cavity with the main housing 111, so that the double-head massage body 14 disposed on the main housing 111 is protected. Specifically, two handles 1111 are fixedly disposed on the main housing 111. Preferably, the two handles 1111 are symmetrically and fixedly disposed on the main housing 111; a plurality of mounting columns 1112 are fixedly disposed on an inner wall of the main housing 111, the rotary telescopic mechanism 13 is movably connected to the plurality of mounting columns 1112, and can perform telescopic movement relative to the plurality of mounting columns 1112; a plurality of through holes 1113 disposed on the main housing 111 in a penetrating manner, and the key assembly 16 and the charging interface 17 penetrate through the main housing 111 through the corresponding through hole 1113, respectively; and the two ends of the main housing 111 are respectively provided with a plurality of clamping grooves 1114 at positions corresponding to the first cover body 112 and the second cover body 113, and the first cover body 112 and the second cover body 113 are detachably disposed in the corresponding clamping grooves 1114 in a clamping manner, respectively. Specifically, a plurality of buckles 1121 are fixedly disposed on inner walls of the first cover body 112 and the second cover body 113 respectively, and positions of the plurality of buckles 1121 are matched with positions of the corresponding clamping grooves 1114. Through cooperation of the buckles 1121 and the clamping grooves 1114, the first cover body 112 and the second cover body 113 can be detachably clamped on the main housing 111 respectively.

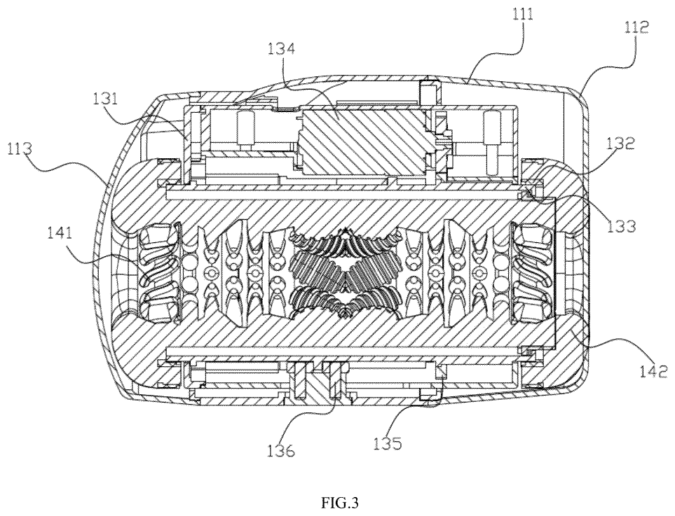

As shown in FIG. 3 to FIG. 6, in this embodiment, the rotary telescopic mechanism 13 includes a support housing 131, two rotary bearings 132, a rotating cylinder 133, a driving structure 134, a transmission rack 135, and a guide structure 136. The support housing 131 is slidably disposed on the main housing 111 in a penetrating manner and can move relative to the main housing 111, so that the telescopic operation of the double-head massage body 14 is realized; the two rotary bearings 132 are oppositely disposed at two ends of the support housing 131, respectively; two ends of the rotating cylinder 133 are movably disposed on the two rotary bearings 132 respectively, and a telescopic guide sliding rail 1331 is fixedly and obliquely disposed on the rotating cylinder in a surrounding manner, the double-head massage body 14 is detachably disposed in the rotating cylinder 133, and the rotating cylinder 133 can rotate relative to the support housing 131 through the two rotary bearings 132, so that the rotation operation of the double-head massage body 14 is realized; the transmission rack 135 is fixedly disposed on the rotating cylinder 133 in a surrounding manner; the driving structure 134 can rotate forwards and backwards, is disposed on the support housing 131 and is in transmission connection with the transmission rack 135 and drives the transmission rack 135 to rotate, and the rotating cylinder 133 rotates along with rotation of the transmission rack 135; and the guide structure 136 is fixedly disposed on the housing assembly 11 and penetrates through the support housing 131 to be in contact connection with the telescopic guide sliding rail 1331, and performs limiting and guiding operation on the telescopic guide sliding rail 1331. The driving structure 134 drives the rotating cylinder 133 to rotate relative to the support housing 131 through the transmission rack 135, so that the double-head massage body 14 disposed on the rotating cylinder 133 rotates along with the rotating cylinder, meanwhile, through cooperation of the telescopic guide sliding rail 1331 and the guide structure 136, the support housing 131 is driven to move relative to the main housing 111, so that the double-head massage body 14 disposed on the rotating cylinder 133 also moves along with the support housing 131, and through forward and reverse rotation of the driving structure 134, the telescopic operation of the double-head massage body 14 is realized.

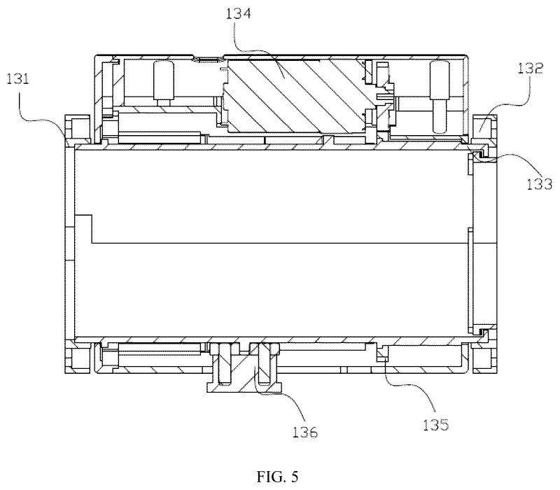

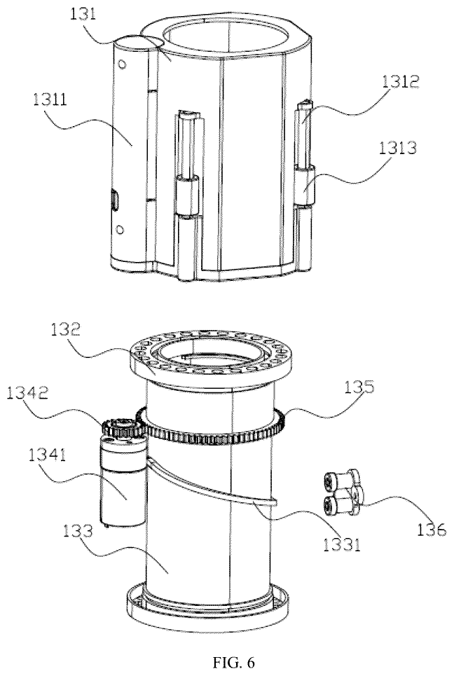

As shown in FIG. 5 and FIG. 6, specifically, a motor housing 1311 is detachably and fixedly disposed on the support housing 131, and the driving structure 134 is disposed in the motor housing 1311. In this embodiment, the motor housing 1311 can movably penetrate through the main housing 111; and a plurality of guide shafts 1312 are fixedly disposed on the support housing 131, a linear bearing 1313 is movably disposed on each guide shaft 1312 in a penetrating manner, the linear bearing 1313 is fixedly disposed in the corresponding mounting column 1112, the guide shaft 1312 can move relative to the linear bearing 1313, and the linear bearing 1313 performs limiting and guiding operation on the movement of the guide shaft 1312. Specifically, the driving structure 134 includes a gear motor 1341 and a driving gear 1342, and the gear motor 1341 can rotate forwards and backwards and is fixedly disposed in the motor housing 1311; and the driving gear 1342 is fixedly disposed on a rotating shaft of the gear motor 1341 and is in transmission connection with the transmission rack 135 in a meshing manner, and the gear motor 1341 drives the transmission rack 135 to rotate through the driving gear 1342, so that the rotating cylinder 133 is driven to perform forward and reverse rotation operation.

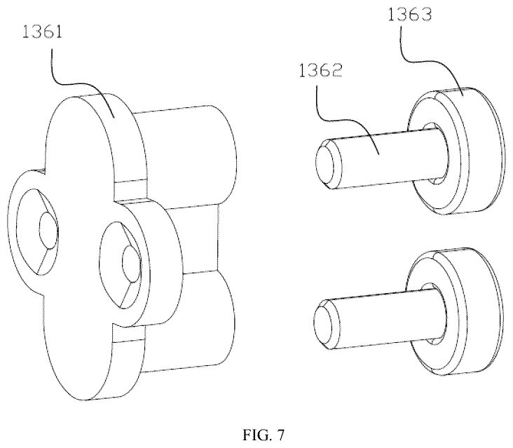

As shown in FIG. 5 to FIG. 7, specifically, the guide structure 136 includes a mounting base 1361, two mounting shafts 1362, and two bearings 1363. The mounting base 1361 is detachably and fixedly disposed in the main housing 111 in a penetrating manner; the two mounting shafts 1362 are fixedly disposed on the mounting base 1361 respectively and penetrate through the support housing 131 respectively; and the two bearings 1363 are rotatably disposed on the corresponding mounting shafts 1362 respectively, a telescopic guide sliding rail 1331 is movably disposed between the two bearings 1363, and the two bearings 1363 perform limiting and guide operation on the movement of the telescopic guide sliding rail 1331.

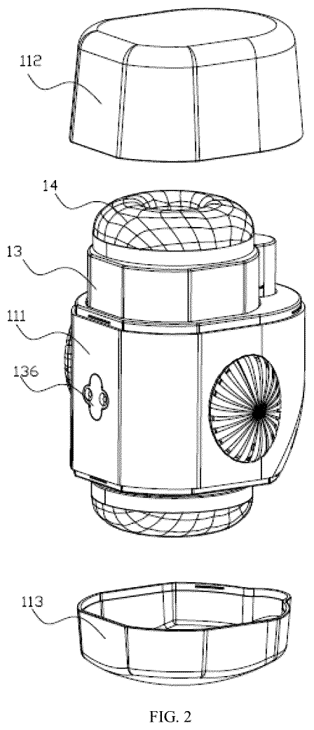

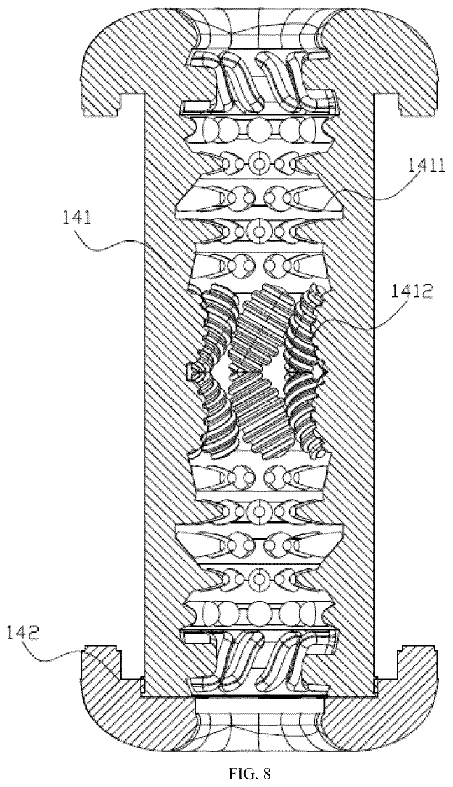

As shown in FIG. 2, FIG. 3, and FIG. 8, the double-head massage body 14 is made of a soft silica gel material and includes a massage main body 141 and a massage cover body 142; and the massage main body 141 is a hollow cavity with openings at two ends. In this embodiment, the two ends of the massage main body 141 are disposed in a communicating manner; and in other embodiment, the two ends of the massage main body 141 are not in communication with each other. The massage cover body 142 is detachably disposed on the massage main body 141 in a clamping manner, so that the double-head massage body 14 is conveniently mounted in the rotating cylinder 133, and meanwhile, the double-head massage body 14 can be conveniently cleaned. Specifically, a plurality of convex points 1411 and a plurality of spiral strips 1412 are respectively disposed on an inner wall of the massage main body 141, and the plurality of convex points 1411 and the plurality of spiral strips 1412 are integrally formed with the massage main body 141. In some embodiments, the inner wall of the massage main body 141 is only provided with a plurality of convex points 1411, and the plurality of convex points 1411 are integrally formed with the massage main body 141; and in some other embodiments, the inner wall of the massage main body 141 may also be provided with only a plurality of spiral strips 1412, and the plurality of spiral strips 1412 are integrally formed with the massage main body 141.

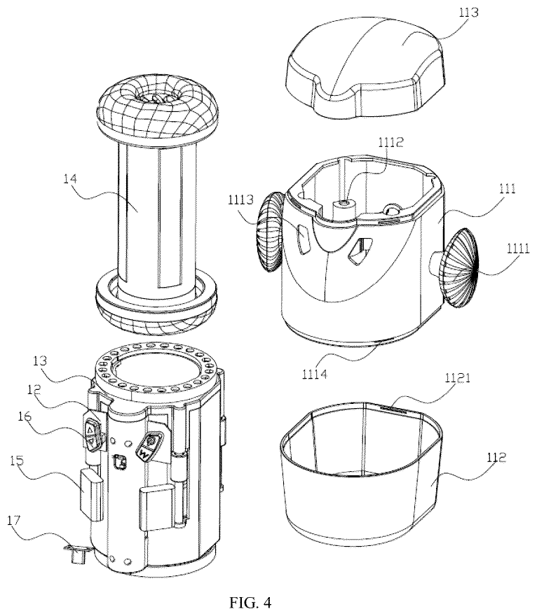

As shown in FIG. 3 and FIG. 4, in this embodiment, the battery assembly 15 adopts a polymer lithium ion battery; the key assembly 16 includes a switch key and a function key, the switch key controls the opening and closing of the double-head rotary telescopic masturbation cup 10, and the function key sets the function of the double-head rotary telescopic masturbation cup 10; and the charging interface 17 may adopt one or more of a DC charging interface, a Type C charging interface, a Micro USB charging interface, and a Lightning charging interface, and in this embodiment, the charging interface 17 adopts the Type C charging interface.

It should be noted that a specific working process of a double-head rotary telescopic masturbation cup 10 provided by the present invention is that: the user holds the two handles 1111 with two hands respectively, and then presses the key assembly 16 to select a proper massage mode. The gear motor 1341 sequentially passes through the driving gear 1342 and the transmission rack 135 to drive the rotating cylinder 133 to rotate relative to the support housing 131, so that a rotating function of the double-head massage body 14 disposed on the rotating cylinder 133 is realized, meanwhile, the support housing 131 is driven to move relative to the main housing 111 through cooperation of the telescopic guide sliding rail 1331 disposed on the rotating cylinder 133 and the guide structure 136, so that the double-head massage body 14 disposed on the rotating cylinder 133 also moves along with the support housing 131, and the telescopic operation of the double-head massage body 14 is synchronously realized through forward and reverse rotation of the driving structure 134.

The technical features of the above embodiments can be combined in any way. To simplify the description, not all possible combinations of the technical features in the embodiments are described. However, as long as there is no contradiction in the combinations of these technical features, all possible combinations should be considered to fall within the scope of the specification.

The above embodiments only represent several implementation manners of the present invention, and the description thereof is relatively specific and detailed but should not be construed as limiting the scope of the present invention. It should be noted that for those of ordinary skill in the art, several modifications and improvements can be made without departing from the concept of the present invention and these modifications and improvements should all fall within the protection scope of the present invention. Therefore, the protection scope of the present invention shall be subject to the appended claims.

What is claimed is:

1. A double-head rotary telescopic masturbation cup, comprising:
a housing assembly;
a rotary telescopic mechanism movably disposed in the housing assembly, wherein the rotary telescopic mechanism can synchronously perform rotation operation and telescopic operation relative to the housing assembly; and
a double-head massage body detachably disposed in the rotary telescopic mechanism in a penetrating manner, wherein
the rotary telescopic mechanism comprises: a support housing slidably disposed in the housing assembly in a penetrating manner; two rotary bearings respectively arranged on the support housing; a rotating cylinder with two ends movably disposed on the two rotary bearings respectively, and a telescopic guide sliding rail and a transmission rack fixedly disposed on the rotating cylinder in a surrounding manner respectively, wherein the double-head massage body is detachably disposed in the rotating cylinder, and the telescopic guide sliding rail is obliquely disposed; a driving structure disposed on the support housing and in transmission connection with the transmission rack, which can rotate forwards and backwards, wherein the driving structure drives the rotating cylinder to rotate through the transmission rack; and a guide structure fixedly disposed on the housing assembly and penetrating through the support housing to be in contact connection with the telescopic guide sliding rail, which performs limiting and guiding operation on the telescopic guide sliding rail.

2. The double-head rotary telescopic masturbation cup according to claim 1, wherein the housing assembly comprises: a main housing, which is a hollow cavity with openings at two ends, wherein the rotary telescopic mechanism movably penetrates through the main housing; and a first cover body and a second cover body detachably disposed at the two ends of the main housing respectively.

3. The double-head rotary telescopic masturbation cup according to claim 2, wherein two handles are fixedly disposed on the main housing.

4. The double-head rotary telescopic masturbation cup according to claim 2, wherein a plurality of mounting columns are fixedly disposed on an inner wall of the main housing respectively; and a plurality of guide shafts are fixedly disposed on the support housing, a linear bearing is movably disposed on each guide shaft in a penetrating manner, the linear bearing is fixedly disposed in the corresponding mounting column, and the guide shaft can move relative to the corresponding linear bearing.

5. The double-head rotary telescopic masturbation cup according to claim 2, wherein a plurality of clamping grooves are disposed at the two ends of the main housing respectively; and a plurality of buckles are fixedly disposed on inner walls of the first cover body and the second cover body respectively, and positions of the plurality of buckles are matched with positions of the corresponding clamping grooves.

6. The double-head rotary telescopic masturbation cup according to claim 1, wherein a motor housing is detachably and fixedly disposed on the support housing, and the driving structure is disposed in the motor housing.

7. The double-head rotary telescopic masturbation cup according to claim 6, wherein the driving structure comprises: a gear motor, which can rotate forwards and backwards, wherein the gear motor fixedly disposed in the motor housing; and a driving gear fixedly disposed on a rotating shaft of the gear motor, which is in transmission connection with the transmission rack in a meshing manner.

8. The double-head rotary telescopic masturbation cup according to claim 2, wherein the guide structure comprises: a mounting base detachably and fixedly disposed in the main housing in a penetrating manner; two mounting shafts fixedly disposed on the mounting base respectively and penetrating through the support housing respectively; and two bearings rotatably disposed on the corresponding mounting shafts respectively.

9. The double-head rotary telescopic masturbation cup according to claim 1, wherein the double-head massage body is made of a soft silica gel material.

10. The double-head rotary telescopic masturbation cup according to claim 9 wherein the double-head massage body comprises: a massage main body, which is a hollow cavity with openings at two ends; and a massage cover body detachably disposed on the massage main body in a clamping manner.

11. The double-head rotary telescopic masturbation cup according to claim 10, wherein the two ends of the massage main body are disposed in a communicating manner.

12. The double-head rotary telescopic masturbation cup according to claim 10, wherein the two ends of the massage main body are not in communication with each other.

13. The double-head rotary telescopic masturbation cup according to claim 10, wherein a plurality of convex points and a plurality of spiral strips are respectively disposed on an inner wall of the massage main body.

14. The double-head rotary telescopic masturbation cup according to claim 13, wherein the plurality of convex points and the plurality of spiral strips are integrally formed with the massage main body.

15. The double-head rotary telescopic masturbation cup according to claim 10, wherein a plurality of convex points are disposed on an inner wall of the massage main body, and the plurality of convex points are integrally formed with the massage main body.

16. The double-head rotary telescopic masturbation cup according to claim 10, wherein a plurality of spiral strips are disposed on an inner wall of the massage main body, and the plurality of spiral strips are integrally formed with the massage main body.

17. The double-head rotary telescopic masturbation cup according to claim 1, further comprising a circuit board, a battery assembly, a key assembly, and a charging interface, wherein the circuit board and the battery assembly are fixedly disposed in the housing assembly respectively; the key assembly is disposed on the circuit board and penetrates through the housing assembly; the charging interface is fixedly disposed on the housing assembly in a penetrating manner; and the circuit board is electrically connected to the rotary telescopic mechanism, the battery assembly, the key assembly, and the charging interface, respectively.

18. The double-head rotary telescopic masturbation cup according to claim 17, wherein the battery assembly adopts a polymer lithium ion battery.

19. The double-head rotary telescopic masturbation cup according to claim 17, wherein the electrical interface adopts one or more of a DC charging interface, a Type C charging interface, a Micro USB charging interface, and a Lightning charging interface.
